(19) United States
(12) Patent Application Publication
(10) Pub. No.: US 2026/0049872 A1
(43) Pub. Date: Feb. 19, 2026

(54) TEMPERATURE INDICATOR FOR CONTINUOUSLY MONITORING THE MAINTENANCE OF A TEMPERATURE PREVAILING IN THE VICINITY OF THE TEMPERATURE INDICATOR, RELATED METHOD AND COMPUTER PROGRAM

(71) Applicant: Ciprian Militaru, Stuttgart (DE)

(72) Inventor: Ciprian Militaru, Stuttgart (DE)

(21) Appl. No.: 18/802,060

(22) Filed: Aug. 13, 2024

(51) Int. Cl. G01K 1/02

(52) U.S. Cl. CPC G01K 1/02

(57) ABSTRACT

In an embodiment a temperature indicator is configured to continuously monitor a maintenance of a temperature in a vicinity of the temperature indicator within a first preset temperature range, wherein at least one second temperature range is presettable on the temperature indicator via a mechanically actuable operating element, wherein the second temperature range differs from the first temperature range, and wherein the second temperature range is monitorable by the temperature indicator instead of the first temperature range after actuation of the actuable operating element.

### TECHNICAL FIELD

The invention relates to a temperature indicator. In particular, the invention relates to a temperature indicator for continuously monitoring the maintenance of a temperature in the vicinity of the temperature indicator within a first preset temperature range. The invention further relates to a method for continuously monitoring, by means of a temperature indicator, the maintenance of a temperature in the vicinity of the temperature indicator within a preset temperature range. Moreover, the invention relates to a computer program and a computer-readable medium.

### BACKGROUND

The above-mentioned temperature indicators are known in various designs and with varying functional scope. In particular, temperature indicators enable reliable temperature monitoring for temperature-sensitive products during transport and storage, and are used to immediately detect and provide evidence of whether the delivered product has been exposed to temperatures that do not comply with regulations during transport or storage.

In particular, temperature indicators are used in the pharmaceutical sector, in the transportation and storage of blood products, in the food sector, and in many other areas where cold chain compliance is important.

Hence, compliance with cold chains may be improved and damage to temperature-sensitive goods may be prevented. If a cold chain has been interrupted in a way that does not comply with regulations, a temperature indicator secures the chain of evidence and the damage can be attributed to the responsible person.

If a temperature indicator is used to determine that a cold chain has not been maintained in accordance with regulations, products that are no longer marketable can be rendered harmless immediately and thus no longer reach the consumer. In this respect, the use of temperature indicators already is a fundamental necessity in the above-mentioned medical and pharmaceutical sectors. Alternatively, questionable products that initially appear dubious due to the temperature indicator display can for this reason be subjected to another bacteriological test and can then be discarded or used again, depending on the result.

In addition, the knowledge of the presence of temperature indicators in the stored and/or transported goods has a psychological effect on the personnel involved to the extent that any negligence in maintaining the cold chain is not even considered, as there is no doubt that such can be detected by the temperature indicators used.

Temperature indicators are generally intended to be positioned directly adjacent to the stored or transported products, in other words intended to be stored or transported together with them in order to detect the temperature of the products via the temperature in the vicinity of the temperature indicator.

Temperature indicators are known which are designed for single or multiple use.

A known disposable temperature indicator, which is marketed under the name “TI-10”, comprises a factory-preset temperature range which the device can monitor, e.g. 2-8° C. (degrees Celsius or degrees centigrade). Here, such a temperature range is referred to as a first preset temperature range.

The known temperature indicator comprises at least one power source, a microprocessor with means for executing a method for monitoring the preset temperature range, and a temperature sensor. Furthermore, an operating element (start button) is implemented to start the measurement process. After the start button is pressed, the recording of measured values starts with a delay of 10 minutes. Finally, two visual displays are implemented, namely a green LED (OK) to indicate compliance with the temperature range during monitoring, and a red LED (alarm) to indicate in case the measured temperature did not lie within the first preset temperature range during the entire monitoring process.

The internal processor collects the current temperature value approximately every minute and compares it with the preset range. If a value is outside the range, the visual display for the alarm is activated. Otherwise, the green display for OK remains activated.

Also known are disposable or reusable temperature indicators which also offer periodic recording of the measured values. For this purpose, interfaces can be provided in order to read out the stored measured values. Such devices are also referred to as temperature data loggers or temperature loggers. In the context of the present invention, these devices are also comprised by the term temperature indicator used here.

However, temperature indicators known in the state of the art are disadvantageous in terms of versatility and variability of the temperature range to be monitored.

If a temperature range is preset in the device at the factory as a first preset temperature range, the device in question cannot be used for another temperature range that deviates from said first preset temperature range.

Common temperature ranges for the above-mentioned applications are e.g. 2-8° C. and 15-25° C. If the user of temperature indicators has to cover different temperature ranges for storage and transportation of the products he processes, he must therefore procure and keep a variety of differently preset temperature indicators. This leads to an unnecessary use of capital and storage capacity.

Temperature indicators that have been purchased may even have to be disposed of unused if their intended service life has lapsed or, in very practical terms, the condition of the battery they contain no longer allows them to be used for a longer time. In such a case, the invested capital would be lost and valuable resources wasted.

On the other hand, if the user only keeps in stock temperature indicators for a certain temperature range, he comprehensibly cannot cover monitoring tasks for another temperature range at short notice, but must first procure suitable temperature indicators for this purpose.

To date, it has not been possible to adapt temperature indicators in situ, i.e. at the place where the storage or transport task begins, and/or by the personnel entrusted with this task, and/or quickly and in large quantities, to the individual monitoring task at hand.

### SUMMARY

Embodiments enable greater variability and faster adaptability with regard to temperature indicators and their monitorable temperature range, even with regard to a large number of temperature indicators, and/or even by personnel who is not specially trained for this purpose, and/or even without specially suited equipment.

Embodiments provide a temperature indicator configured to:
continuously monitor a maintenance of a temperature in a vicinity of the temperature indicator within a first preset temperature range,
wherein at least one second temperature range is presettable on the temperature indicator via a mechanically actuable operating element,
wherein the second temperature range differs from the first temperature range, and wherein the second temperature range is monitorable by the temperature indicator instead of the first temperature range after actuation of the actuable operating element.

The temperature indicator mentioned at the beginning is developed further in such a way that at least one second temperature range can be preset on the temperature indicator via a mechanically actuable operating element, wherein said second temperature range differs from the first temperature range, and wherein said second temperature range can be monitored by the temperature indicator instead of the first temperature range after actuation of the operating element.

Further embodiments provide a method according to the invention for continuously monitoring, by means of a temperature indicator, the maintenance of a temperature in the vicinity of the temperature indicator within a preset temperature range, comprising: a) enabling the user to select the monitoring of a temperature range via a mechanically actuable operating element of the temperature indicator, wherein the presetting of a second temperature range, which differs from a first preset temperature range, instead of the first temperature range, can be carried out via the operating element, b) optionally, active query of a user's selection, c) detecting and processing the actuation or non-actuation of the operating element by the user and corresponding presetting of the selected temperature range to be monitored, d) optionally, detecting and processing an actuation by the user to start monitoring the selected temperature range, e) continuous monitoring of the maintenance of the temperature in the vicinity of the temperature indicator within the selected temperature range.

The method can preferably be carried out using a temperature indicator according to the invention. Further, the method preferably comprises the steps in the order a) to e) as given above.

Other embodiments provide a temperature indicator according to the invention comprising a mechanically actuable operating element and means adapted to perform the steps of the above method. Said temperature indicator may preferably further comprise the features discussed above.

Yet other embodiments provide a computer program according to the invention comprising instructions which cause the aforementioned temperature indicator to perform the steps of the above method.

The computer program according to the invention could alternatively also be referred to as a computer program product without deviating from the inventive idea.

Finally, according to the invention, the aforementioned computer program may be stored on a computer-readable medium.

The present invention creates a wider range of applications for temperature indicators without requiring noticeably more resources. Temperature indicators can thus be provided with two or more predetermined temperature ranges, between which a selection can be made by means of at least one mechanical operating element, depending on current requirements. Within a temperature indicator, for example, a selection can be offered between a temperature range to be monitored of 2-8° C. and of 15-25° C. Such temperature ranges are common in the respective field.

The company using temperature indicators therefore no longer needs to procure and keep available two different types of indicators. Instead, the purchase of a single model is sufficient. This also prevents stored and previously unused temperature indicators from having to be disposed of unused due to the ageing of the contained battery.

The temperature indicator according to the invention can be preset very quickly and in large quantities using the mechanically actuable operating element. If, for example, a correctly preset temperature indicator has to be placed in each cardboard box or pallet during the manufacture or transportation of a product, this can be done very quickly and without sources of error. The temperature indicators can be preset on site according to the temperature range currently required and placed on or in the goods to be monitored.

Another major advantage is that the temperature range can easily be preset by the personnel on site, who are otherwise responsible for packaging, storing or transporting the goods to be processed. Specialist knowledge or special equipment is not required. Preferably, the mechanically actuable operating element can be actuated with a user's finger.

Any presetting of temperature indicators to different temperature ranges by means of a computer or similar electronic device via an interface of a temperature indicator lies expressly not within the scope of the present invention, since the advantages according to the invention are not achieved in this way. Such a presetting can neither be carried out quickly and individually, nor in large quantities, nor by untrained personnel, nor without appropriate equipment (namely both software and hardware) and specialist knowledge, nor at the location of a storage or transportation task. Such possible solutions therefore do not form a starting point for the present invention.

In the following, the aspects according to the invention are discussed further, for which purpose reference is made in part to non-limiting advantageous embodiments and further developments of the invention. The features of already discussed and subsequent advantageous further developments can be realized individually or in any combination, whereby further advantageous embodiments of the invention are created.

Throughout the present discussion of configurations, further developments, examples and embodiments of the devices and products according to the invention, methods to use the devices and products and uses of the devices and products according to the invention are also described. These methods and uses also expressly lie within the scope of the present invention.

The features of advantageous further developments of devices according to the invention described above and below may also be realized in a corresponding manner in products, methods and uses according to the invention, either individually or in any combination, thereby creating further advantageous embodiments of the invention.

In a first preferred embodiment of the temperature indicator according to the invention, the operating element comprises a button, a lever or a knob. Such an operating element is easy to identify and actuate, in particular with a finger of the user. The operating element can also be labeled accordingly for this purpose, in particular with an indication of the temperature range that can be preset when actuating the operating element.

In another preferred further development, it is possible to switch between at least two temperature ranges to be monitored using a single operating element. For example, a first preset temperature range can be assigned to the non-actuated operating element. Actuating the operating element, on the other hand, can mean a change to a second temperature range, and thus its presetting.

In an alternative embodiment, two or more mechanically actuable operating elements can be implemented. Each presettable temperature range can be assigned its own operating element. Furthermore, a clear link can be established between the respective operating element and the assigned temperature range by means of appropriate labeling. This means that the probability of an incorrect presetting is very low.

Preferably, a first operating element is provided for presetting a first temperature range, and a second operating element is provided for presetting a second temperature range.

It is also preferable that an actuated operating element can indicate the currently preset temperature range via its actuation state. For example, a pivoted lever or slide switch can clearly indicate the currently preset temperature range by its current position. The same applies to a knob or button that assumes a lowered position after being actuated and then returns to a raised position after being actuated again.

In another advantageous embodiment, an optical indicator for the currently preset temperature range is implemented. This means that the currently preset temperature range can be displayed very reliably in addition to an optional check of the preset temperature range via an actuated operating element.

Preferably, an optical indicator, in particular an LED, can be used for this purpose. It is also preferable that each presettable temperature range can be assigned its own optical indicator on the surface of the temperature indicator, which goes into operation after the corresponding selection. It is particularly preferable that an LED is assigned to each temperature range, which can indicate the currently preset range through its state of operation.

In a further advantageous development, the temperature indicator simultaneously comprises means for recording the measured temperature values. A corresponding temperature indicator could thus also be referred to as a temperature data logger or a temperature logger. The temperature indicator can preferably also offer a periodic recording of the measured temperatures, and the period between the logging of successive measurement values can preferably also be adjustable.

The temperature indicator preferably comprises a data interface. In particular, this may be a USB interface or a wireless interface, especially Bluetooth or NFC. In particular, an optional interface can be used to query and transmit stored temperature measurement curves, provided the temperature indicator comprises the above-mentioned means for recording measured temperature values. Additional or alternative settings or queries can also be implemented via an interface, e.g. uploading of updated firmware or of an update, performing a reset, or querying the battery status.

In another advantageous embodiment, the mechanically actuable operating element is displayed as a control panel on a screen of the temperature indicator. This requires the temperature indicator to have a corresponding screen or display. In such a case, the operating element can preferably be displayed as a control panel, as a touch field, or as a button on the screen of the temperature indicator. An operating element displayed in this way can preferably be operated by touching, pressing or swiping with the user's finger, similar to the operation of a smartphone or tablet.

In this context, a further development of the method according to the invention also proves to be advantageous, in which the mechanically actuable operating element is displayed as a control panel on a screen of the temperature indicator.

A corresponding advantageous further development of the computer program according to the invention comprises commands that effect such a displaying.

The temperature indicator preferably comprises a processor, in particular a microprocessor. Such a processor can in particular control the detection of the measured temperature values, but in particular also offer and/or process the selection of the preset temperature range, and can use the corresponding range as the basis for subsequent operation.

The temperature indicator can be designed as a disposable or reusable device.

The temperature indicator preferably comprises a power source, in particular a battery. A commercially available button cell may be sufficient for this purpose, in particular in the case of a disposable device.

The temperature indicator preferably comprises at least one temperature sensor for detecting temperature values. The temperature sensor can be installed inside the device. Alternatively, the temperature sensor can be arranged on the surface of the device.

The temperature indicator preferably comprises a start button that can be used to trigger the measurement process. Preferably, a time delay is implemented between pressing the start button and the actual start of the measured value recording. Such a time delay can preferably be around 10 minutes or longer. Such a time delay gives the device sufficient time to acclimatize to the intended location before recording the first measured value, so that incorrect measured values and false alarms do not occur by reason of the previous handling and actuation of the device. A start button can optionally also be designed as a one-time and irreversibly triggerable break seal.

Preferably, the temperature indicator comprises a visual indicator for the correct operation of the device within the preset temperature range, and/or comprises a visual indicator for the indication of non-compliant operation (alarm), namely if the preset temperature range has not been maintained during the detection of temperature values. In particular, the device can comprise a green LED, which can light up or flash continuously when the parameters are complied with, and can comprise a red LED, which can light up or flash continuously when an alarm occurs. Preferably, in order to avoid manipulation, an optical indicator of such an alarm status cannot be switched off by the user.

A further method according to the invention for continuously monitoring, by means of a temperature indicator, the maintenance of a temperature in the vicinity of the temperature indicator within a preset temperature range, comprises: a) enabling the user to select the monitoring of a temperature range via a mechanically actuable operating element of the temperature indicator, wherein the presetting of a second temperature range, which differs from a first preset temperature range, instead of the first temperature range, can be carried out via the operating element, c) detecting and processing the actuation or non-actuation of the operating element by the user and corresponding presetting of the selected temperature range to be monitored, e) continuous monitoring of the maintenance of the temperature in the vicinity of the temperature indicator within the selected temperature range.

The method can preferably be carried out using a temperature indicator according to the invention. Furthermore, the method preferably comprises the steps in the order a), c) and e) as given above.

Preferably, the method may additionally comprise the following steps: b) active query of a user's selection, and/or d) detecting and processing an actuation by the user to start monitoring the selected temperature range, in particular in the order as apparent from the assignment of the letters in brackets.

A further method according to the invention for presetting a temperature range of a temperature indicator configured to continuously monitor the maintenance of a temperature in the vicinity of the temperature indicator within the preset temperature range comprises: a) enabling the user to select the monitoring of a temperature range via a mechanically actuable operating element of the temperature indicator, wherein the presetting of a second temperature range, which differs from a first preset temperature range, instead of the first temperature range, can be carried out via the operating element, c) detecting and processing the actuation or non-actuation of the operating element by the user and corresponding presetting of the selected temperature range to be monitored within the temperature indicator.

Preferably, the method may additionally comprise the following step: b) active query of a user's selection, in particular in the order as apparent from the assignment of the letters in brackets.

A temperature indicator, in particular according to one or more of the above embodiments, may preferably further comprise means adapted to perform the steps of any one of the above methods.

A computer program according to one or more of the preceding embodiments may preferably further comprise instructions to cause a temperature indicator according to one or more of the preceding embodiments to perform the steps of any one of the above methods.

### BRIEF DESCRIPTION OF THE DRAWINGS

Supplementary or in addition to the advantageous embodiments and further developments of the teaching already discussed, embodiments of devices, products, uses and methods according to the invention shown in the drawings to the extent of FIGS. 1 to 6 are explained in more detail below. However, the examples discussed with reference to the drawings do not limit the invention to the examples shown. In discussing the embodiments with reference to the drawings, generally preferred embodiments and further developments of the teaching are also shown.

Further developments of the advantageous embodiments described above with features of the embodiments described below, just like further developments of the embodiments described below with features of the embodiments described above, expressly form further advantageous embodiments of the invention, and thus form part of the present disclosure.

With regard to the following explanation of the figures, it should generally be noted that, for reasons of clarity, reference signs already shown in previous figures and already explained above in this respect have in some cases not been repeated in subsequent figures and/or are in some cases not explained again on the basis of these subsequent figures. For the explanation of such reference signs and the associated technical features, reference is therefore made in full to the respective description of the corresponding preceding figures, in order to avoid repetition.

FIG. 1 shows a partially schematic front view of a first preferred embodiment of a temperature indicator according to the invention, here as a disposable temperature indicator without a data interface.

FIG. 2 shows a partially schematic front view of a second preferred embodiment of a temperature indicator according to the invention, here as a disposable temperature indicator with a data interface.

FIG. 3 shows a partially schematic front view of a third preferred embodiment of a temperature indicator according to the invention, here as a reusable temperature indicator with a data interface.

FIG. 4 shows a partially schematic front view of a fourth preferred embodiment of a temperature indicator according to the invention, here as a reusable temperature indicator with a screen.

FIG. 5 shows a flowchart of a preferred embodiment of a method according to the invention for continuously monitoring of a temperature by means of a temperature indicator.

FIG. 6 shows a flowchart of a preferred embodiment of a method according to the invention for presetting a temperature range of a temperature indicator.

### DETAILED DESCRIPTION OF ILLUSTRATIVE EMBODIMENTS

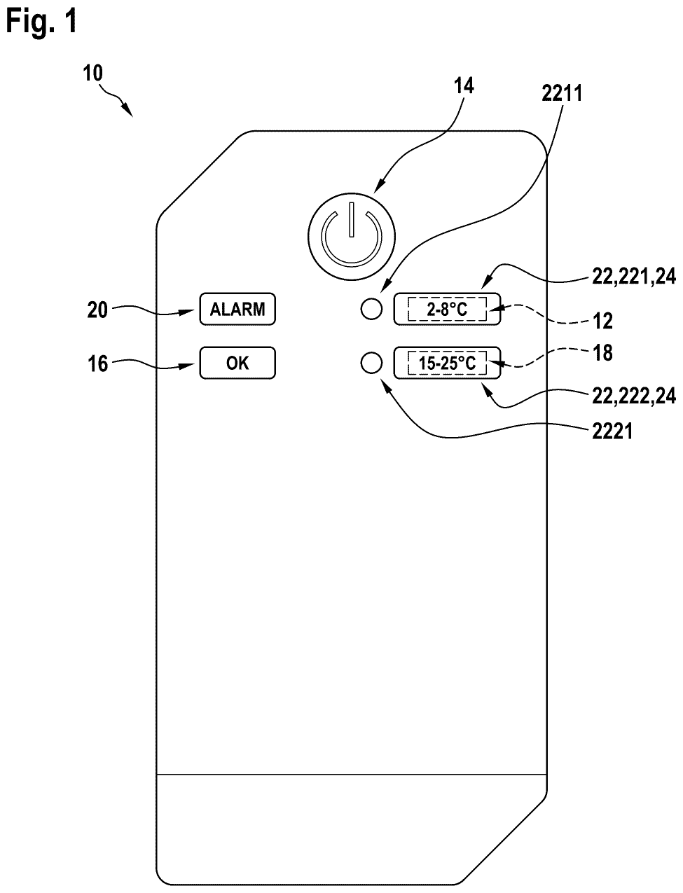

FIG. 1 shows a partially schematic front view of a first preferred embodiment of a temperature indicator 10 according to the invention, here as a disposable temperature indicator 10 without a data interface.

The temperature indicator 10 is generally used to continuously monitor the maintenance of a temperature in the vicinity of the temperature indicator 10 within a first preset temperature range 12.

For this purpose, the temperature indicator 10 initially has a power source, a microprocessor and a temperature sensor. These components are located inside the temperature indicator 10 and are therefore not visible in this illustration. The microprocessor controls the determination of the measured temperature values. A suitable time delay is preset after the measuring process is triggered, e.g. 10-30 min. The microprocessor also controls the time interval between the recording of successive measured values, e.g. 1 min.

The temperature indicator 10 has a flat shape in the form of a label and can therefore be attached directly to the product to be monitored, e.g. by sticking it on. The temperature indicator 10 shown is suitable, for example, for monitoring the temperature of blood preserves, which are stored in bags known for this purpose.

The embodiments in the following figures, on the other hand, have a greater thickness due to the respective technical features and are rather intended to be placed between the products to be monitored.

The temperature indicator 10 comprises a start button 14, which can be pressed to trigger the measurement process. The above-mentioned time delay is implemented between pressing the start button 14 and the actual start of detecting the measured values. Such a time delay gives the device 10 sufficient time to acclimatize at the intended location before detecting the first measured value.

Furthermore, the temperature indicator 10 comprises a first optical indicator 16 for the indication of correct operation of the device 10 within the preset temperature range 12, 18, and a second optical indicator 20 for the indication of non-compliant operation (alarm), namely if the preset temperature range 12, 18 has not been maintained during the detection of temperature readings. The first optical indicator 16 is designed here as a green LED, and the second optical indicator is designed as a red LED.

At least one second temperature range 18, which differs from the first temperature range 12, can be preset on the temperature indicator 10 via a mechanically actuable operating element 22.

In this example, the first temperature range 12 is 2-8° C. (degrees Celsius or degrees centigrade), and the second temperature range 18 is 15-25° C.

After actuating the operating element 22, the second temperature range 18 can be monitored by the temperature indicator 10 instead of the first temperature range 12.

In this example, two mechanically actuable operating elements 22 are implemented.

A first operating element 221 is provided for presetting the first temperature range 12, and a second operating element 222 is provided for presetting the second temperature range 18.

In this respect, after actuating the second operating element 222, the second temperature range 18 instead of the first temperature range 12 can be monitored by the temperature indicator 10, and conversely, after actuating the first operating element 221, the first temperature range 12 instead of the second temperature range 18 can be monitored.

A simpler embodiment of the invention not shown here, on the other hand, may comprise a fixed preset first temperature range 12 and only one mechanically actuable operating element 22. By actuation of the operating element 22 the second temperature range 18 could be preset instead of the fixed preset first temperature range 12. By actuating the single operating element 22 again, the first range 12 could then preferably be preset again.

In the embodiment shown, both operating elements 221, 222 are each designed as a button 24. The respective temperature range 12, 18 is printed on the respective operating element 221, 222.

To further facilitate operation and to avoid operating errors, a first optical indicator 2211 is also assigned to the first operating element 221, and a second optical indicator 2221 is assigned to the second operating element 222. Both optical indicators 2211, 2221 are implemented as LEDs. The optical indicators 2211, 2221 allow the respective preset and current temperature range 12, 18 to be displayed optically, so that errors in the presetting can be reliably avoided.

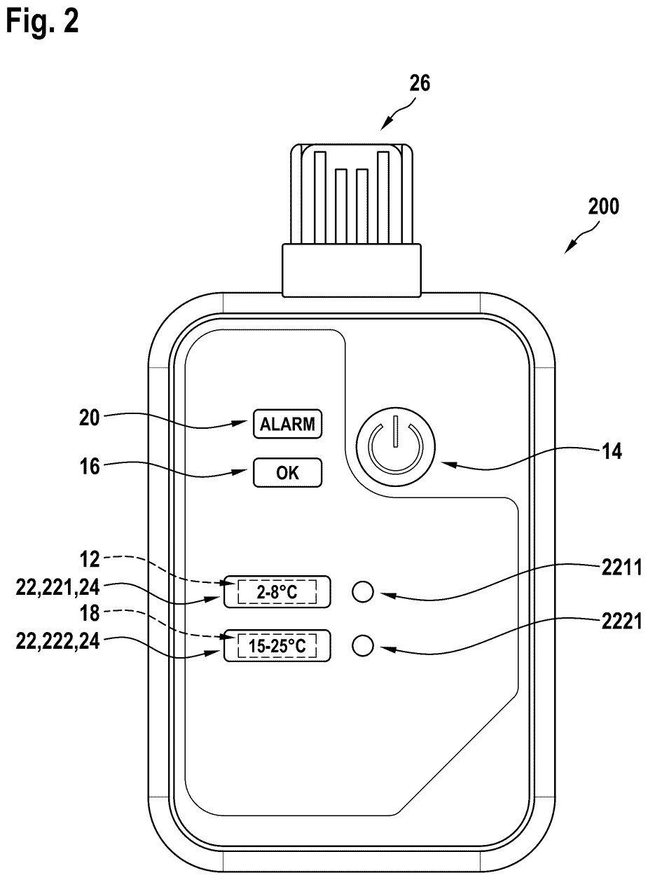

FIG. 2 shows a partially schematic front view of a second preferred embodiment of a temperature indicator 200 according to the invention, here as a disposable temperature indicator 200 with a data interface 26.

The temperature indicator 200 shown here has a function for recording and for reading out the measured temperature values. The temperature indicator 200 according to this example can therefore also be referred to as a temperature data logger or a temperature logger. The data interface 26 is designed here as a USB interface and is used in particular for reading out the stored measured values.

Apart from that, the other features and the respective reference signs correspond to those in FIG. 1, to which together with the associated description reference is made in order to avoid repetition.

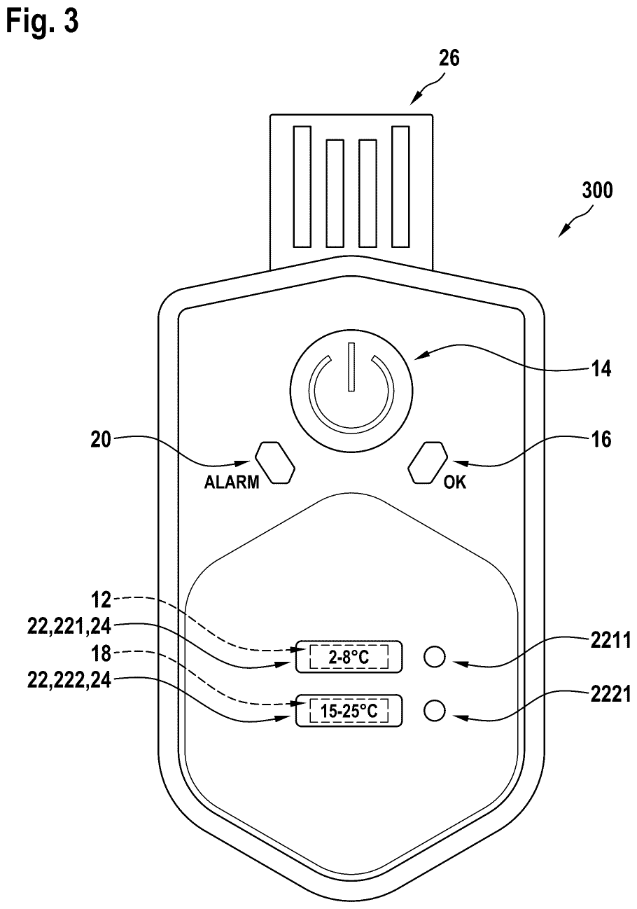

FIG. 3 shows a partially schematic front view of a third preferred embodiment of a temperature indicator 300 according to the invention, which, in contrast to FIG. 2, is designed as a reusable temperature indicator 300, but, in contrast to FIG. 1, is also equipped with a data interface 26.

Like the example in FIG. 2, the temperature indicator 300 shown here therefore has a functionality for recording and reading out the measured temperature values. In this example, the temperature indicator 300 can therefore also alternatively be referred to as a temperature data logger or a temperature logger. Here, the data interface 26 also is a USB interface and is used in particular for reading out the stored measured values.

Apart from that, the other features and the respective reference signs correspond to those in FIGS. 1 and 2, to which together with the associated description reference is made in order to avoid repetition.

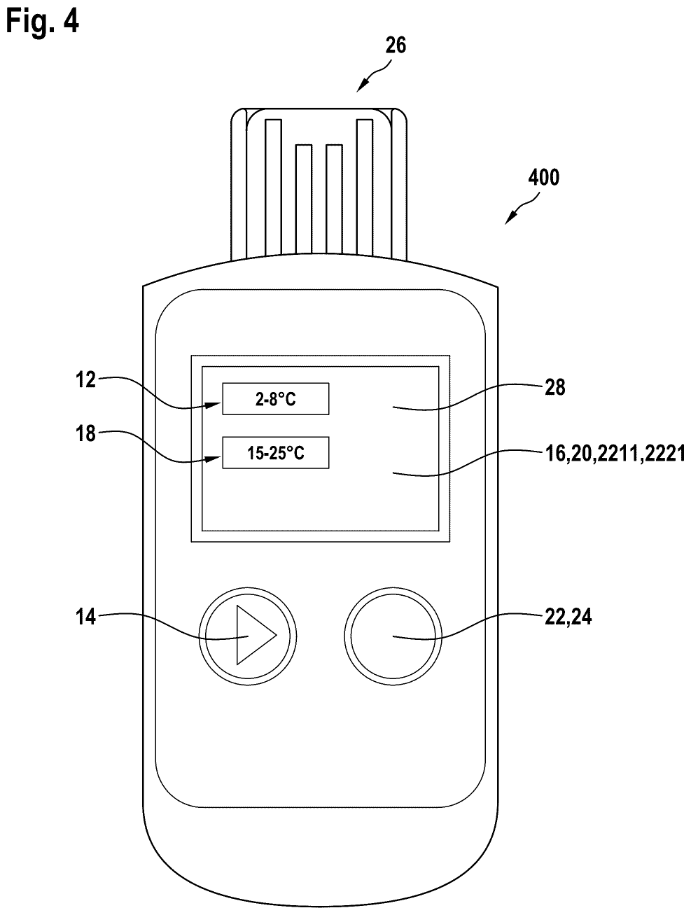

FIG. 4 shows a partially schematic front view of a fourth preferred embodiment of a temperature indicator 400 according to the invention, here as a multi-way temperature indicator 400 with a data interface 26 and a display 28.

In contrast to the example in FIG. 3, the reusable temperature indicator 400 according to the embodiment shown here has a screen 28, which could also be referred to as a display.

The screen 28 is used in particular to display the last measured temperature value or the battery status.

The screen 28 offers the advantage that the currently preset temperature range 12, 18 can be displayed on the screen 28. In this respect, and in this example, a single mechanically actuable operating element 22 may be sufficient to switch back and forth between the temperature ranges 12, 18. The ranges 12, 18 can be displayed accordingly on the screen 28 during selection. By pressing the start button 14, the respective temperature range 12, 18 can then be set for the following measurement.

Alternatively, depending on the functionality of the screen 28, and in a further embodiment not shown here, one or more mechanically actuable operating elements 22, 221, 222 (cf. FIGS. 1-3) can be displayed on the screen 28 of the temperature indicator 400, and can be selected directly on the screen 28, comparable to the functionality of a smartphone, by touching or swiping with a finger. In such a case, a button 24 could even be dispensed with.

Due to the displayability of any data and states on the screen 28, the screen 28 in this embodiment also simultaneously serves as a first optical indicator 16 for operation in accordance with the regulations (OK), as a second optical indicator 20 for operation not in accordance with the regulations (alarm), as a first optical indicator 2211 for the preset first temperature range 12, and as a second optical indicator 2221 for the preset second temperature range 18.

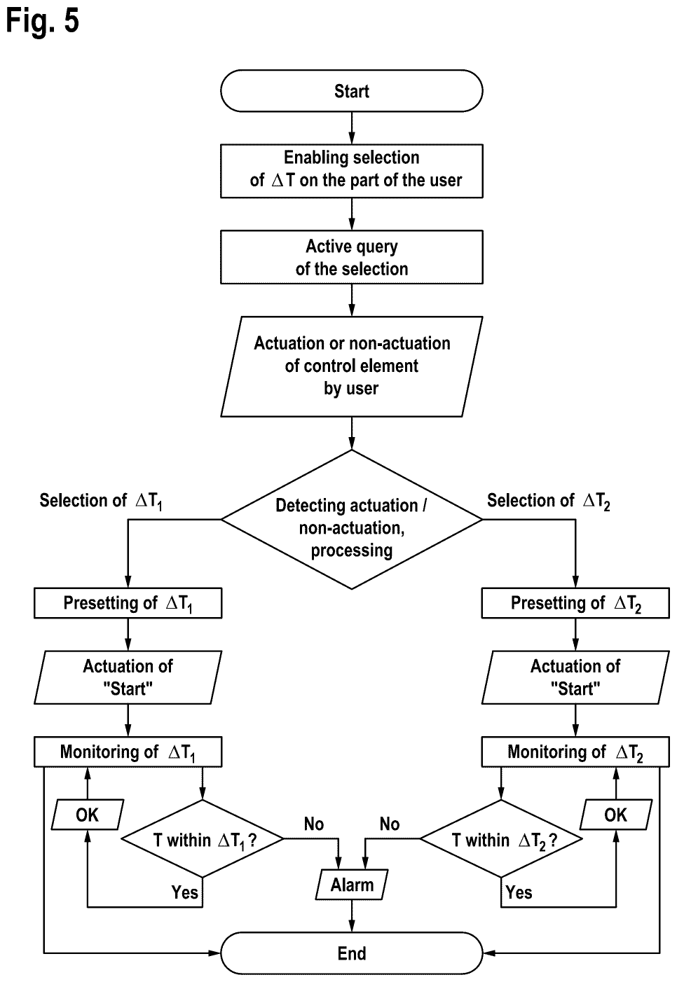

FIG. 5 shows a flowchart of a preferred embodiment of a method according to the invention for continuously monitoring a temperature by means of a temperature indicator 10, 200, 300, 400.

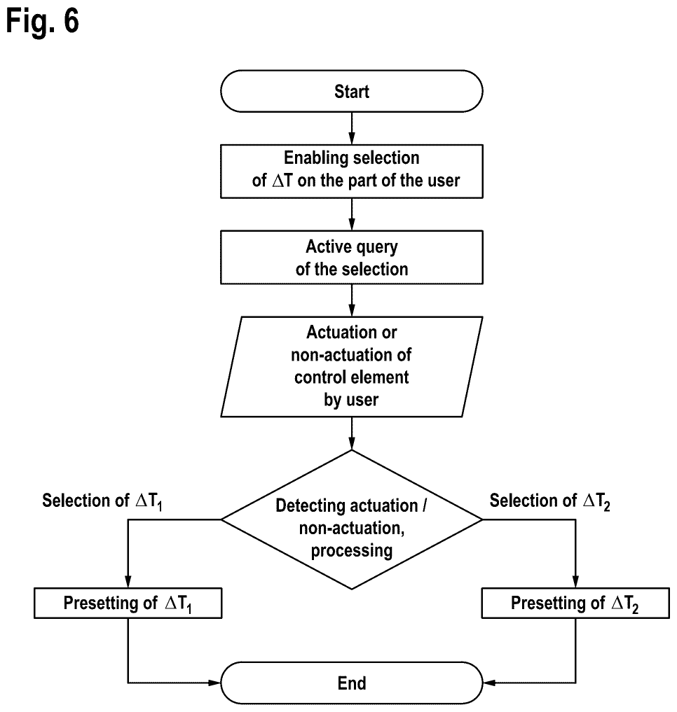

Both here and in the following FIG. 6, the first temperature range 12 is referred to as ΔT₁, and the second temperature range 18 is referred to as ΔT₂.

Depending on the intended design of the method and/or depending on the temperature indicator 10, 200, 300, 400 used, the “Active query of the selection”step may also be omitted.

The step “Actuation of START” means an actuation of a start button or a similar device by the user. Depending on the intended design of the method and/or depending on the temperature indicator 10, 200, 300, 400 used, this step may also be omitted.

Apart from that, the embodiment shown in the flowchart of FIG. 5 is self-explanatory.

FIG. 6 shows a flowchart of a preferred embodiment of a method according to the invention for presetting a temperature range of a temperature indicator 10, 200, 300, 400.

Depending on the intended design of the method and/or depending on the temperature indicator 10, 200, 300, 400 used, the “Active query of the selection”step may also be omitted.

Apart from that, the embodiment shown in the flowchart of FIG. 6 is self-explanatory.

### List of Reference Signs

10, 200, 300, 400 Temperature indicator, device
12 First temperature range, ΔT₁
14 Start button
16 First optical indicator (for operation, OK)
18 Second temperature range, ΔT₂
20 Second optical indicator (for operation, alarm)
22 Mechanically actuable operating element
221 First (mechanically actuable) operating element
222 Second (mechanically actuable) operating element
24 Button (operating element)
2211 First optical indicator (for first operating element/preset first temperature range)
2221 Second optical indicator (for second operating element/
Preset second temperature range)
26 Data interface, interface
28 Screen, display

What is claimed is:

1. A temperature indicator configured to:
continuously monitor a maintenance of a temperature in a vicinity of the temperature indicator within a first preset temperature range,
wherein at least one second temperature range is presettable on the temperature indicator via a mechanically actuable operating element,
wherein the second temperature range differs from the first temperature range, and wherein the second temperature range is monitorable by the temperature indicator instead of the first temperature range after actuation of the actuable operating element.

2. The temperature indicator according to claim 1, wherein the operating element comprises a button, a lever or a knob.

3. The temperature indicator according to claim 1, wherein a change between at least two temperature ranges to be monitored is implementable via a single operating element.

4. The temperature indicator according to claim 1, wherein two or more mechanically actuable operating elements are implemented.

5. The temperature indicator according to claim 4, wherein a first mechanically actuable operating element is provided for presetting the first temperature range, and a second mechanically actuable operating element is provided for presetting the second temperature range.

6. The temperature indicator according to claim 1, wherein the mechanically actuable operating element is configured to indicate a currently preset temperature range via its actuation state.

7. The temperature indicator according to claim 1, further comprising an optical indicator for a currently preset temperature range.

8. The temperature indicator according to claim 1, wherein the temperature indicator simultaneously comprises means for recording measured temperature values.

9. The temperature indicator according to claim 1, wherein the temperature indicator comprises a data interface.

10. The temperature indicator according to claim 1, wherein the mechanically actuable operating element is displayable as a control panel on a screen of the temperature indicator.

11. A method comprising:
continuously monitoring, by a temperature indicator, a maintenance of a temperature in a vicinity of the temperature indicator within a preset temperature range;
enabling, by a mechanically actuable operating element of the temperature indicator, a user to select a monitoring of a temperature range,
wherein presetting of a second temperature range, which differs from a first preset temperature range, instead of the first temperature range, can be carried out via the mechanically actuable operating element;
optionally, active querying of a user's selection;
detecting and processing an actuation or a non-actuation of the mechanically actuable operating element by the user and corresponding presetting of a selected temperature range to be monitored,
optionally, detecting and processing an actuation by the user to start monitoring the selected temperature range,
continuous monitoring the maintenance of the temperature in the vicinity of the temperature indicator within the selected temperature range.

12. The method according to claim 11, wherein the mechanically actuable operating element is displayed as a control panel on a screen of the temperature indicator.

13. The temperature indicator comprising:
the mechanically actuable operating element; and
means for performing the method according to claim 11.

14. A computer program comprising instructions that cause the temperature indicator to perform the method according to claim 11.

15. A computer-readable medium on which the computer program according to claim 14 is stored.
